(19) United States
(12) Patent Application Publication
(10) Pub. No.: US 2004/0079241 A1
(43) Pub. Date: Apr. 29, 2004

(54) Transfer tool for food products

(76) Inventor: Roy E. Hook, Powell, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/687,790

(22) Filed: Oct. 17, 2003

Related U.S. Application Data
(60) Provisional application No. 60/419,448, filed on Oct. 18, 2002.

(51) Int. Cl. A23L 1/00

(52) U.S. Cl. 99/485

(57) ABSTRACT

A transfer tool for transporting a row of workpieces, such as hamburger patties, located as a first position on a surface, such as a grill, to another location. The tool has an elongated, rigid, workpiece-receiving panel, an end support extending transversely from the panel, and an elongated, hand-grippable handle attached to the end support and extending, in an operable orientation of the tool, above the panel. Preferably, the workpiece-receiving panel is contoured to have an upwardly concave, bowl-like surface for containing liquid on the panel and there is an end support at each end of the panel which includes a liquid impervious wall extending upwardly from the panel for containing liquid on the panel to prevent spillage. Preferably, the handle extends between and is attached at its opposite ends to the end supports and is parallel to the panel.

### BACKGROUND OF THE INVENTION

1. Field of the Invention

This invention relates generally to a tool for transferring an entire row of objects from one surface to another and particularly relates to a cooking utensil for transferring a row of food products from one location on a grill surface to another location on the grill.

2. Description of the Related Art

A variety of food cooking techniques employ a planar surface to support a food product while it is being heated for cooking or temperature maintenance. The grill is one of the most common cooking appliances used for the cooking of food workpieces, particularly in restaurants. A grill typically has a cooking surface which is heated by a heat source located below the surface. A food product, such as a hamburger patty, is laid upon the grill and heated for a time interval which is a function of the grill temperature and the nature of the food product. In other cooking appliance operations, such as broiling or baking, a planar sheet, such as a cookie sheet, is often employed, such as in a cooking oven, for supporting a food product while it is being cooked.

Food products require removal from the heated support surface when cooking is completed. Because food products are ordinarily hot and contact with the food product would be painful to a human operator, a tool is often used for lifting the food product and turning or transferring it to another support surface. The most common such tool is a spatula or similar implement. A spatula has a small planar, usually metal, sheet with a handle extending from the sheet so the handle can be grasped by the user, the sheet slid under the food product and the food product turned over or transferred to another location where the spatula is tilted and the food product is allowed to slide from the spatula under the force of gravity.

Many modern, high volume, rapid service restaurants, such as those serving hamburgers, use double sided grills which also have a heated, upper, cooking platen. The upper cooking platen is lowered onto the top of the hamburger so that cooking proceeds with the application of heat from both the top and bottom. However, the operation of such restaurants, in order to meet the high volume demand and the rapid service expectations of their customers, requires that a large quantity of hamburgers be cooked in advance of ordering and then held in a staging area for subsequent serving. A staging area is typically also a heated, planar surface and commonly is a part of the same grill appliance. Consequently, numerous cooked hamburger patties are ready to be transferred from a cooking area to a staging area at the same time.

The transfer of these hamburger patties is ordinarily performed by an operator using a spatula. However, a spatula is usually designed to receive and support only one hamburger patty. Therefore, the operator is required to move each hamburger patty, one at a time, from the cooking area to the staging area. This is a time consuming procedure requiring repetitive motions back and forth between the cooking area and the staging area. Not only does it require substantial time, but the repetitive motions also interfere with access to the staging area by employees who are attempting to retrieve and serve the hamburger patties from the staging area.

Additionally, because a conventional spatula is designed to slide easily under a food product supported on a surface, it is entirely flat, with no sidewalls or upturned flanges. Spatulas therefore permit juices and hot grease to spill over their edges as a food product is transferred from one location to another causing drippings which require periodic cleaning and detract from the clean appearance of the grill.

It is therefore an object and feature of the invention to provide a tool for transferring multiple, hot, food workpieces from a support surface to another location in a single operation which speeds up the procedure and also substantially reduces spillage.

A further object and feature of the invention is to provide such a transfer tool which is comfortable and convenient for an operator to use and makes both the loading of food products onto the tool and the unloading of food products from the tool a relatively easy, rapid, manual manipulation for an operator.

A further object and feature of the invention is to provide a transfer tool which is easy to thoroughly clean after usage in order to contribute to the maintenance of a safe and sanitary food service operation in compliance with health regulations.

### BRIEF SUMMARY OF THE INVENTION

The invention is a transfer tool for transporting a row of workpieces, such as hamburger patties, located as a first position on a surface, such as a grill, to a second location. The tool has an elongated, rigid, workpiece-receiving panel, an end support extending transversely from the panel, and an elongated, hand-grippable handle attached to the end support and extending, in an operable orientation of the tool, above the panel. Preferably, the workpiece-receiving panel is contoured to have an upwardly concave surface for containing liquid on the panel and there is an end support at each end of the panel which includes a liquid impervious wall extending upwardly from the panel for also containing liquid on the panel to prevent spillage from the sides and ends of the panel. Preferably, the handle extends between and is attached at its opposite ends to the end supports and is parallel to the workpiece-receiving panel.

### BRIEF DESCRIPTION OF THE SEVERAL VIEWS OF THE DRAWINGS

FIG. 1 is a view in perspective of the preferred embodiment of the invention.

FIG. 2 is a top view of the transfer tool of FIG. 1.

FIG. 3 is a view in side elevation of the transfer tool of FIG. 1.

FIG. 4 is an end view of the transfer tool of FIG. 1.

FIG. 5 is view in section taken substantially along the line 5-5 of FIG. 3 of the transfer tool of FIG. 1.

FIG. 6 is a bottom view of the transfer tool of FIG. 1.

FIG. 7 is a view in perspective of an operator loading a row of hamburger patties onto the transfer tool of FIG. 1 from a location on a grill.

FIG. 8 is a view in perspective of an operator unloading a row of hamburger patties from the transfer tool of FIG. 1 onto another location on the grill.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

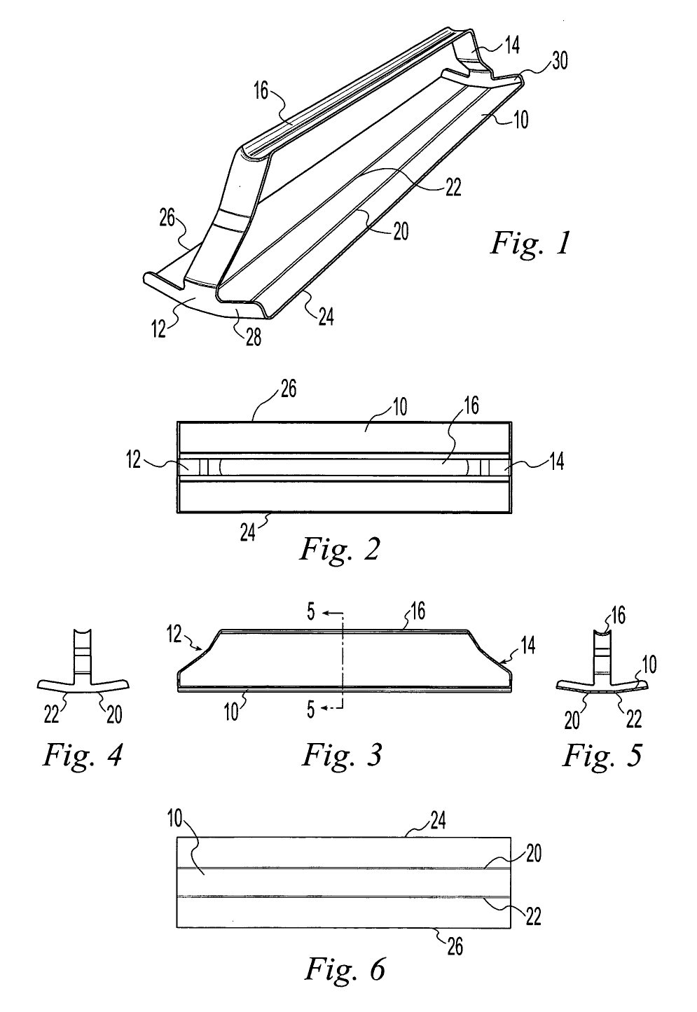

Referring to FIGS. 1-6, the transfer tool has an elongated, rigid, workpiece-receiving panel 10 having a length greater than its width. A pair of end supports 12 and 14 extend transversely and, in an operable orientation of the transfer tool, upwardly from the panel 10. An elongated, hand-grippable handle 16 is attached at it ends to the end supports 12 and 14 and extends the entire length of the panel above and parallel to the panel 10. Preferably, these components and all made of food grade stainless steel and are welded together to form a unitary tool.

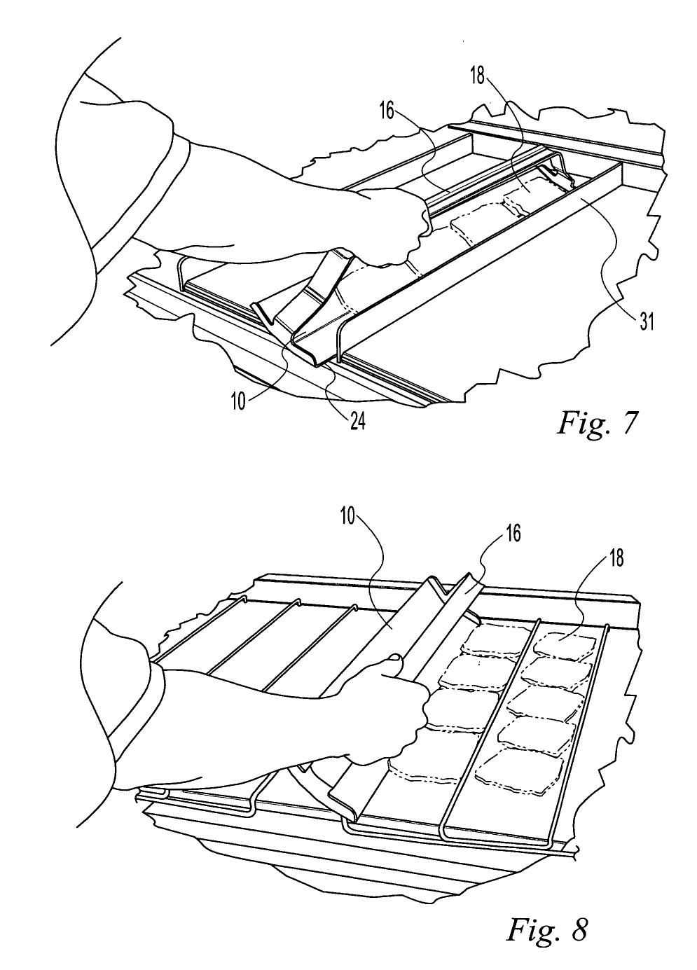

Although the operation of the transfer tool will be described in more detail below, reference to FIGS. 7 and 8 shows how the tool is used. An operator grasps the handle 16, slides the workpiece-receiving panel along the grill surface and under the workpieces, such as a row of hamburger patties 18, lifts the entire row of hamburger patties 18 and carries them to another location where the tool is tilted and the hamburger patties allowed to slide off the panel onto another supporting surface.

The workpiece receiving panel 10 is contoured to have an upwardly facing concave, bowl-like surface for containing juices which were scooped up onto the panel when the patties were loaded. This prevents spillage over the longitudinal edges and retains juices with the patties 18 as the patties are carried from one location to another. The concave contour is accomplished by forming a pair of longitudinal, parallel bends 20 and 22 in the panel 10 with relatively planar rectangular segments between the bends. The concave contour may alternatively be formed by a smooth curved surface or by a more numerous series of more closely spaced bends joined by flat surfaces or facets. The laterally opposite edges 24 and 26 of the panel 10 are parallel linear edges to ensure contact of the edges with the grill surface along the entire length of the panel 10 in order to facilitate sliding the panel 10 under the food workpieces 18.

In order to contain liquid on the panel and prevent spillage off the ends of the panel 10, the end supports 12 and 14 include liquid impervious walls 28 and 30 extending upwardly from the panel 10. Consequently, the operator needs only to avoid only excessive tilting of the tool either laterally or longitudinally in order to avoid spillage from all sides of the transfer tool.

Because the purpose of the tool is to permit the operator to simultaneously load an entire row of food workpieces onto the panel with a single sideward sliding motion along the grill surface, the tool has a length to width aspect ratio of at least 3:1, preferably at least 4:1 and most preferably at least 5:1. The longer the tool, the more workpieces that can be loaded upon it and transferred in a single motion to a second support surface.

Because the tool is intended for use principally with a commercial grill, it is desirable that the workpiece-receiving panel 10 extends at least 80% of the width of the grill surface and more preferably at least 90%. Most preferably, the workpiece-receiving panel 10 has a length substantially the same as the width of the grill surface so that the food workpieces can be cooked in a row extending the entire width of the grill and the entire row can be transferred in a single operation using the transfer tool. If the grill includes upper platens which seat upon the upper side of a cooking food workpiece to provide double sided cooking, then the bottom area of the upper platens defines the cooking area on the grill. Consequently, for such double sided grills, the workpiece-receiving panel 10 desirably extends at least the length of the upper platens. However, for some food workpieces, such as breakfast sausage patties, the food workpieces are smaller than hamburgers and a batch of the smaller patties aligned in row may be the same number or fewer than in a row of hamburger patties. As a result, the row of sausage patties may extend only 50% of the width of the grill and therefore the workpiece-receiving panel 10 needs to extend only 50% of the grill width.

The width of the tool needs only to be about, or slightly wider than, the width of the food workpieces. Although it could be narrower, that would have the undesirable result of the opposite side of the food workpieces bending over the edges 24 and 26 and occasionally breaking off and dropping.

Although a variety of dimensional variations are within the scope of the invention, the preferred embodiment of the transfer tool has a length of 23 inches and a workpiece-receiving panel width of 4.5 inches. The handle 16 is 4 inches above the workpiece-receiving panel 10 and the parallel, linear edges of the panel 10 are 0.5 inch above the central portion of the panel.

It is desirable to provide parallel, spaced apart, removable, divider walls 31 extending upwardly from the grill surface and extending longitudinally the width of the grill. These walls 31 not only provide guides for alignment of the food workpieces 18 along rows, but more importantly provide a wall against which the food workpieces can be pushed when sliding the workpiece-receiving panel 10 under the workpieces 18. When food workpieces 18 are aligned in a row along and adjacent such a wall, the tool can be slid toward the wall with the panel inserted under the row of workpieces and the wall retains the workpieces against lateral sliding on the grill surface so the panel 10 can be easily slid under them.

The operation of the invention is illustrated in FIGS. 7 and 8. Preceding a transfer operation, the food workpieces 18 are laid upon the grill surface in a row, preferably along and parallel to one of the divider walls 31. After the workpieces are cooked, the operator grasps the handle 16, slides the workpiece-receiving panel along the grill surface toward a divider wall 31 and under the entire row of workpieces 18. Sliding the edge 24 along the grill surface not only loads the entire row of hamburger patties 18 onto the workpiece receiveing panel 10, as illustrated in FIG. 7, but also scrapes some juices from the grill surface onto the panel. The operator then lifts the entire row of food workpieces and carries them to another location, such as a staging area for maintaining the temperature of workpieces being held until served, where the tool is tilted and the hamburger patties allowed to slide off the panel onto another supporting surface as illustrated in FIG. 8. The transfer tool not only permits the operator to move the entire row of multiple food workpieces in one manual operation, but also makes it easy for the food workpieces to be deposited at the second area still aligned in a single row.

Because the handle extends the entire length of the transfer tool, an operator is can position the operator's hand at a position nearer one end of the tool in order to longitudinally balance the loaded tool in the event that the tool is used to transfer a partial row of food workpieces. Additionally, because the handle attaches to the tool at the ends of the workpiece-receiving panel, the supports which connect the handle to the panel are beyond the ends of the row of workpieces and therefore do not interfere with the sliding of the food workpieces onto the panel.

While certain preferred embodiments of the present invention have been disclosed in detail, it is to be understood that various modifications may be adopted without departing from the spirit of the invention or scope of the following claims.

1. A transfer tool for transporting a row of workpieces positioned on a surface to another location, the tool comprising:
a. an elongated, rigid, workpiece-receiving panel having a length greater than its width;
b. an end support extending transversely from the panel; and
c. an elongated, hand-grippable handle attached to the end support and extending, in an operable orientation of the tool, above the panel.

2. A transfer tool in accordance with claim 1, wherein the workpiece-receiving panel, in an operable orientation of the tool, is contoured to have an upwardly concave surface for containing liquid on the panel.

3. A transfer tool in accordance with claim 2 wherein the panel has longitudinal bends to form the concave contour.

4. A transfer tool in accordance with claim 2 wherein the end support includes a liquid impervious wall extending upwardly from the panel for containing liquid on the panel and preventing spillage from end of the panel.

5. A transfer tool in accordance with claim 1 wherein the panel has parallel, laterally opposite, linear edges for engaging the workpiece supporting surface.

6. A transfer tool in accordance with claim 1 wherein the handle extends substantially the entire length of the panel.

7. A transfer tool in accordance with claim 1 and further comprising a second end support also extending, in an operable orientation of the tool, upwardly from the panel, wherein both end supports includes a liquid impervious wall extending upwardly adjacent the panel for containing liquid on the panel and preventing spillage from ends of the panel.

8. A transfer tool in accordance with claim 7, wherein the handle extends between and is attached at its opposite ends to the end supports.

9. A transfer tool in accordance with claim 8, wherein the workpiece-receiving panel, in an operable orientation of the tool, is contoured to have an upwardly concave surface for containing liquid on the panel.

10. A transfer tool in accordance with claim 9 wherein the panel has longitudinal bends to form the concave contour.

11. A transfer tool in accordance with claim 9 wherein the panel has parallel, laterally opposite, linear edges for engaging the workpiece supporting surface.

12. A transfer tool in accordance with claim 11 wherein the handle is parallel to the panel.

13. A transfer tool in accordance with claim 12 wherein the panel, end supports and handle are formed integrally.

14. A transfer tool in accordance with claim 1 wherein the panel has a length to width aspect ratio of at least 3:1.

15. A transfer tool in accordance with claim 14, wherein the workpiece-receiving panel, in an operable orientation of the tool, is contoured to have an upwardly concave surface for containing liquid on the panel and has parallel, laterally opposite, linear edges for engaging the workpiece supporting surface, a second end support also extends transversely from the panel, wherein both end supports include a liquid impervious wall extending upwardly from the panel for containing liquid on the panel and preventing spillage from ends of the panel, and wherein the handle is attached at its opposite ends to the end supports.

16. A transfer tool in accordance with claim 14 wherein the panel has a length to width aspect ratio of at least 4:1.

17. A transfer tool in accordance with claim 14 wherein the panel has a length to width aspect ratio of at least 5:1.

18. A transfer tool in accordance with claim 1 for use for transporting a row of food workpieces from a first location on a grill cooking surface to a second location, the grill cooking surface having a width, wherein the length of the workpiece-receiving panel is at least 50% of the width of the grill cooking surface.

19. A transfer tool in accordance with claim 18, wherein the grill has a wall running along and extending above the grill cooking surface for retaining the food workpieces against lateral sliding on the grill surface when the panel is slid under the food workpieces and toward the wall.

20. A transfer tool in accordance with claim 19 wherein the length of the workpiece-receiving panel is at least 80% of the width of the grill cooking surface.

21. A transfer tool in accordance with claim 20 wherein the length of the workpiece-receiving panel is substantially the same as the width of the grill cooking surface.
